(19) United States
(12) Patent Application Publication
(10) Pub. No.: US 2018/0188581 A1
(43) Pub. Date: Jul. 5, 2018

(54) ARRAY SUBSTRATES AND THE MANUFACTURING METHODS THEREOF, AND LIQUID CRYSTAL PANELS

(71) Applicant: WUHAN CHINA STAR OPTOELECTRONICS TECHNOLOGY CO., LTD, Wuhan, Hubei (CN)

(72) Inventors: Xiangyi PENG, Shenzhen, Guangdong (CN); Gui CHEN, Shenzhen, Guangdong (CN); Yafeng LI, Shenzhen, Guangdong (CN)

(73) Assignee: Wuhan China Star Optoelectronics Technology Co., Ltd., Wuhan, Hubei (CN)

(21) Appl. No.: 15/127,389

(22) PCT Filed: Aug. 19, 2016
(86) PCT No.: PCT/CN2016/095966

§ 371 Date: Sep. 19, 2016

(30) Foreign Application Priority Data
Jul. 8, 2016 (CN) 2016105371007

(51) Int. Cl. G02F 1/1333; G02F 1/1339; G02F 1/1343; G02F 1/1362; G02F 1/1368; G06F 3/041

(52) U.S. Cl. CPC G02F 1/13338; G02F 1/13394; G02F 1/134363; G02F 1/136286; G02F 2001/13606; G02F 1/13439; G02F 1/133345; G06F 3/0412; G02F 1/136209; G02F 1/1368

(57) ABSTRACT

The present disclosure relates to an array substrate and the manufacturing method thereof, and a liquid crystal panel. The array substrate includes a transparent substrate; a gate line on the transparent substrate; a touch signal line on the same layer with the gate line, and the touch signal line is arranged on the transparent substrate; a dielectric layer covering the gate line and the touch signal line, and the dielectric layer is configured with at least one first through hole; and a touch electrode arranged on the dielectric layer, the touch electrode electrically connects to the touch signal line via the first through hole. In this way, the storage capacitance may be increased, and the pixels may be fully charged when the resolution rate is high. At the same time, the coupling capacitance between the touch electrode and the Rx signal line may be reduced.

### BACKGROUND OF THE INVENTION

### 1. Field of the Invention

The present disclosure relates to liquid crystal display technology, and more particularly to an array substrate and the manufacturing method thereof, and a liquid crystal panel.

### 2. Discussion of the Related Art

Touch has been a main function of cellular phones. If a phone does not have touch capability, it cannot be called as a cellular phone. Touch technology may include one glass solution (OGS). The touch panel may be embedded between the color filter substrate and a polarizer, i.e., on cell, and may be embedded into the liquid crystal pixels, i.e., in cell. Currently, with respect to the in cell Touch, the common electrode (Com) within the AA area is divided into small blocks, which operate as touch electrodes. Each of the touch electrodes includes a Rx signal line connecting to the Pin of the output end of the IC. Under the circumstance, a metal layer has to be configured to operate as the Rx signal line to transmit the signals from the IC to each of the touch electrodes. The cross sectional views of the In Cell thin film transistor (TFT) of the Traditional Low Temperature Poly-silicon (LTPS) and touch panel (TP) may be referenced in FIG. 1. The Com electrode is divided into small blocks operating as the touch electrode, and the third metal (M3) operates as the Rx signal line. In this way, two insulation layers have to be configured between the pixel electrode (pixel) and the Com electrode (Com). That is, the insulation layer (PV1) is configured between the Com and the third metal (M3), and the insulation layer (PV2) is configured between the third metal (M3) and the pixel electrode (pixel).

### SUMMARY

The present disclosure relates to an array substrate and the manufacturing method thereof, and a liquid crystal panel to increase storage capacitance such that the pixels may be fully charged when the resolution rate is high. At the same time, the coupling capacitance between the touch electrode and the Rx signal line may be reduced.

In one aspect, an array substrate includes: a transparent substrate; a gate line on the transparent substrate; a touch signal line on the same layer with the gate line, and the touch signal line is arranged on the transparent substrate; a dielectric layer covering the gate line and the touch signal line, and the dielectric layer is configured with at least one first through hole; and a touch electrode arranged on the dielectric layer, the touch electrode electrically connects to the touch signal line via the first through hole.

Wherein the touch electrode is a common electrode, a pixel electrode, or a combination of the common electrode and the pixel electrode.

Wherein the dielectric layer is configured with the first through holes at two ends of the gate line such that the common electrode connects to the touch signal line at two ends of the gate line via the first through holes.

Wherein the array substrate further includes a connection electrode on the same layer with the pixel electrode, the dielectric layer is configured with second through holes at two ends of the gate line such that the connection electrode connects to the touch electrode line at two ends of the gate line via the second through holes.

Wherein the pixel electrode is arranged on a layer between the layer of the gate line and the touch signal line and the layer of the common electrode.

Wherein the array substrate further includes a semiconductor pattern layer, a first dielectric layer, a second dielectric layer, a drain, a source, a third dielectric layer, and a fourth dielectric layer, the first dielectric layer covers the semiconductor pattern layer, the gate line and the touch signal line are arranged on the first dielectric layer, the second dielectric layer further covers the gate line and the touch signal line, the drain and the source are arranged on the second dielectric layer and are respectively connect to two ends of the semiconductor pattern layer via at least one third through hole on the first dielectric layer and the second dielectric layer, the third dielectric layer covers the source and the drain, the pixel electrode is arranged on the third dielectric layer, the pixel electrode electrically connects to one of the source and the drain via a fourth through hole on the third dielectric layer, the fourth dielectric layer covers the pixel electrode, and the common electrode is arranged on the fourth dielectric layer.

In another aspect, a manufacturing method of array substrates includes: arranging a gate line and a touch signal line on a transparent substrate, wherein the touch signal line and the gate line are arranged on the same layer on the transparent substrate; and configuring a dielectric layer covering the gate line and the touch signal line, and configuring at least one first through hole on the dielectric layer; and configuring a touch electrode on the dielectric layer, and the touch electrode electrically connects to the touch signal line via the first through hole.

Wherein the touch electrode is a common electrode, a pixel electrode, or a combination of the common electrode and the pixel electrode.

Wherein the step of configuring a touch electrode on the dielectric layer, and the touch electrode electrically connects to the touch signal line via the first through hole further includes: configuring a connection electrode to be on the same layer with the pixel electrode; configuring second through holes at two ends of the same gate line on the dielectric layer such that the connection electrode connects to the touch signal lines on two ends of the gate line via the second through holes.

In another aspect, a liquid crystal panel includes: a color filter (CF) substrate, an array substrate, and a liquid crystal layer between the CF substrate and the array substrate, the array substrate includes: a transparent substrate; a gate line on the transparent substrate; a touch signal line on the same layer with the gate line, and the touch signal line is arranged on the transparent substrate; a dielectric layer covering the gate line and the touch signal line, and the dielectric layer is configured with at least one first through hole; and a touch electrode arranged on the dielectric layer, the touch electrode electrically connects to the touch signal line via the first through hole.

Wherein the touch electrode is a common electrode, a pixel electrode, or a combination of the common electrode and the pixel electrode.

Wherein the dielectric layer is configured with the first through holes at two ends of the gate line such that the common electrode connects to the touch signal line at two ends of the gate line via the first through holes.

Wherein the array substrate further includes a connection electrode on the same layer with the pixel electrode, the dielectric layer is configured with second through holes at two ends of the gate line such that the connection electrode connects to the touch electrode line at two ends of the gate line via the second through holes.

Wherein the pixel electrode is arranged on a layer between the layer of the gate line and the touch signal line and the layer of the common electrode.

Wherein the array substrate further includes a semiconductor pattern layer, a first dielectric layer, a second dielectric layer, a drain, a source, a third dielectric layer, and a fourth dielectric layer, the first dielectric layer covers the semiconductor pattern layer, the gate line and the touch signal line are arranged on the first dielectric layer, the second dielectric layer further covers the gate line and the touch signal line, the drain and the source are arranged on the second dielectric layer and are respectively connect to two ends of the semiconductor pattern layer via at least one third through hole on the first dielectric layer and the second dielectric layer, the third dielectric layer covers the source and the drain, the pixel electrode is arranged on the third dielectric layer, the pixel electrode electrically connects to one of the source and the drain via a fourth through hole on the third dielectric layer, the fourth dielectric layer covers the pixel electrode, and the common electrode is arranged on the fourth dielectric layer.

In view of the above, the touch signal line and the gate line are arranged on the same layer on the substrate. The dielectric layer covers the gate line and the touch signal line, and the dielectric layer is configured with a first through hole. The touch electrode is configured on the dielectric layer, and the touch electrode electrically connects to the touch signal line via the first through hole. The storage capacitance may be increased, and the pixels may be fully charged when the resolution rate is high.

### BRIEF DESCRIPTION OF THE DRAWINGS

Embodiments of the invention will now be described more fully hereinafter with reference to the accompanying drawings, in which embodiments of the invention are shown. Obviously, the descriptions below are merely the examples of the embodiments, those of ordinary skills may easily conceive other drawings without creative efforts based on these drawings.

FIG. 1 is a schematic view of one conventional LCD.

FIG. 2 is a schematic view of the liquid crystal panel in accordance with a first embodiment.

FIG. 3 is a schematic view of the array substrate in accordance with the first embodiment.

FIG. 4 is a schematic view of the liquid crystal panel in accordance with a second embodiment.

FIG. 5 is a schematic view of the array substrate in accordance with the second embodiment.

FIG. 6 is a flowchart illustrating the manufacturing method of the array substrate in accordance with one embodiment.

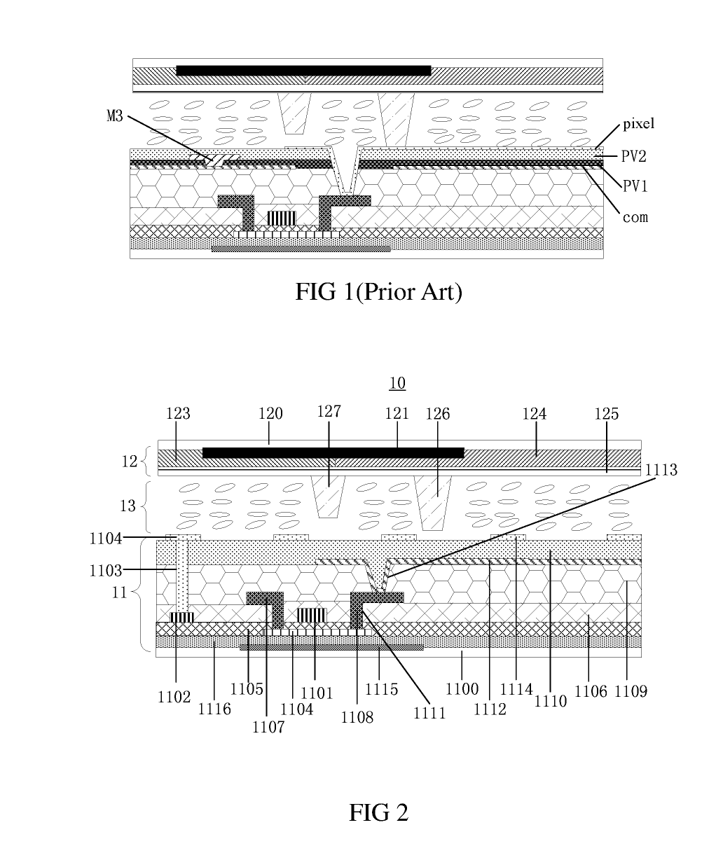

### DETAILED DESCRIPTION OF THE EMBODIMENTS

Embodiments of the invention will now be described more fully hereinafter with reference to the accompanying drawings, in which embodiments of the invention are shown.

FIG. 2 is a schematic view of the liquid crystal panel in accordance with a first embodiment. As shown in FIG. 2, the liquid crystal panel 10 includes an array substrate 11, a color-filter (CF) substrate 12, and a liquid crystal layer 13 between the CF substrate 12 and the array substrate 11. The CF substrate 12 includes a glass substrate 120, at least one black matrix 121 on the glass substrate 120, and a filter film, including a red filter film 123, a green filter film 124, and a blue filter film 125. The CF substrate 12 is configured with a post-shaped spacer, including a main post spacer (PS) 126 and a sub post spacer (PS) 127. The post spacers are configured to avoid optical leakage and to operate as a support.

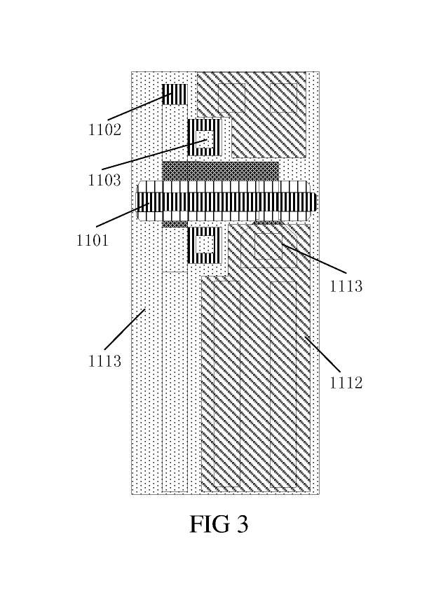

Referring to FIGS. 2 and 3, the array substrate 11 includes a transparent substrate 1100, a gate line 1101 on the transparent substrate 1100, a touch signal line 1102 on the same layer with the gate line 1101, and a dielectric layer covering the gate line 1101 and the touch signal line 1102. In addition, the dielectric layer is configured with a first through hole 1103. The array substrate 11 also includes a touch electrode 1104 electrically connecting to the touch signal line 1102 via the first through hole 1103, wherein the touch electrode 1104 is a common electrode.

The array substrate 11 further includes a semiconductor pattern layer 1104, a first dielectric layer 1105, a second dielectric layer 1106, a drain 1107, a source 1108, a third dielectric layer 1109, and a fourth dielectric layer 1110. The first dielectric layer 1105 covers the semiconductor pattern layer 1104, the gate line 1101 and the touch signal line 1102 are arranged on the first dielectric layer 1105, the second dielectric layer 1106 further covers the gate line 1101 and the touch signal line 1102, the drain 1107 and the source 1108 are arranged on the second dielectric layer 1106 and are respectively connect to the two ends of the semiconductor pattern layer 1104 via at least one third through hole 1111 on the first dielectric layer 1105 and the second dielectric layer 1106, the third dielectric layer 1109 covers the source 1108 and the drain 1107, a pixel electrode 1112 is arranged on the third dielectric layer 1109, the pixel electrode 1112 electrically connects to one of the source 1108 and the drain 1107 via a fourth through hole 1113 on the third dielectric layer 1109, the fourth dielectric layer 1110 covers the pixel electrode 1112, and a common electrode 1114 is arranged on the fourth dielectric layer 1110. A masking metallic layer 1115 and a fifth dielectric layer 1116 are configured between the transparent substrate 1100 and the semiconductor pattern layer 1104.

In the embodiment, the gate line 1101 and the touch signal line 1102 are made by the manufacturing process of a first metal (M1), and the source 1108 and the drain 1107 are made by the manufacturing process of a second metal (M2). The touch signal line 1102 is the Rx signal line. As the touch electrode 1104 is the common electrode, the corresponding dielectric layer includes the second dielectric layer 1106, the third dielectric layer 1109, and the fourth dielectric layer 1110. As such, the thickness of the dielectric layer between the touch electrode and the Rx signal line is increased, and the coupling capacitance between the touch electrode and the Rx signal line is reduced.

The dielectric layer is configured with first through holes 1103 at two ends of the gate line 1101 such that the common electrode 1114 connects to the touch signal line 1102 at two ends of the gate line 1101 via the first through hole 1103. In this way, there is no need to manufacture a third metal (M3) to be the touch signal line, and thus one masking process may be excluded. As such, only one dielectric layer is needed between the pixel electrode 1112 and the common electrode 1114, i.e., the fourth dielectric layer 1110. The storage capacitance may be increased, and the pixels may be fully charged when the resolution rate is high. At the same time, the coupling capacitance between the touch electrode and the Rx signal line may be reduced.

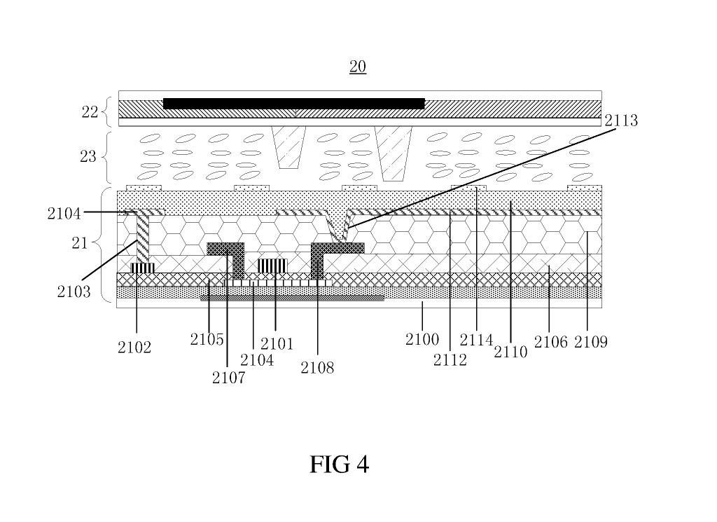

FIG. 4 is a schematic view of the liquid crystal panel in accordance with a second embodiment. The liquid crystal panel 20 includes an array substrate 21, a CF substrate 22, and a liquid crystal layer 23 between the CF substrate 22 and the array substrate 21. The structure of the CF substrate 22 is similar to that in FIG. 2, and thus the descriptions are omitted hereinafter.

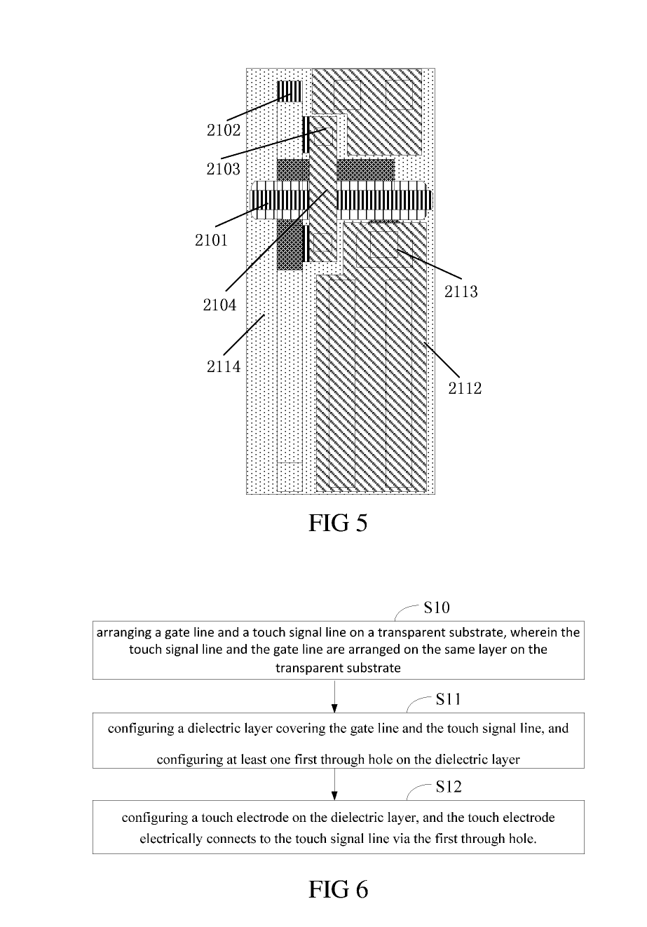

The structure of the array substrate 21 may be referenced in FIGS. 4 and 5. The array substrate 21 includes a transparent substrate 2100, a gate line 2101 on the transparent substrate 2100, a touch electrode line 2102 on the same layer with the gate line 2101, a dielectric layer covering the gate line 2101 and the touch electrode line 2102. In addition, the dielectric layer is configured with a first through hole 2103. The array substrate 21 also includes a touch electrode 2104 arranged on the dielectric layer, and the dielectric layer electrically connects to the touch electrode line 2102 via the first through hole 2103.

The difference between the array substrate 21 and the array substrate 11 resides in that the touch electrode 2104 is the pixel electrode. Correspondingly, the dielectric layer includes a second dielectric layer 2106 and a third dielectric layer 2109. As such, the thickness of the dielectric layer between the touch electrode and the Rx signal line is increased, and the coupling capacitance between the touch electrode and the Rx signal line is reduced.

The pixel electrode 2112 is arranged between the 2101, the touch electrode line 2102 and the common electrode 2114. The pixel electrode 2112 electrically connect to one of the source 2018 and the drain 2107 via a fourth through hole 2113 on the third dielectric layer 2109. The array substrate 21 further includes a connection electrode 2104 on the same layer with the pixel electrode 2112. The dielectric layer is configured with the second through holes 2103 at two ends of the gate line 2101 such that the connection electrode 2104 connects to the touch electrode line 2102 at two ends of the gate line 2101 via the second through hole 2103. In this way, there is no need to manufacture a third metal (M3) to be the touch signal line, and thus one masking process may be excluded. As such, only one dielectric layer is needed between the pixel electrode 2112 and the common electrode 2114, i.e., the fourth dielectric layer 2110. The storage capacitance may be increased, and the pixels may be fully charged when the resolution rate is high. At the same time, the coupling capacitance between the touch electrode and the Rx signal line may be reduced.

In the embodiment, the touch electrode may be one of the common electrode and the pixel electrode or may be the combination of the common electrode and the pixel electrode. That is, the touch electrode may be the common electrode (referring to FIGS. 2 and 3), or may be the pixel electrode (referring to FIGS. 4 and 5). Alternatively, a portion of the touch electrode is the common electrode, and a portion of the touch electrode is the pixel electrode.

FIG. 6 is a flowchart illustrating the manufacturing method of the array substrate in accordance with one embodiment. The structure of the array substrate may be referenced in FIG. 2 or 4. As shown in FIG. 6, the manufacturing method of the array substrate includes the following steps.

In step S10, arranging a gate line and a touch signal line on a transparent substrate, wherein the touch signal line and the gate line are arranged on the same layer on the transparent substrate.

In the embodiment, the gate line and the touch signal line are manufactured at the same time with the manufacturing process of the first metal (M1). The gate line operates as the gate of the thin film transistor (TFT), and the touch signal line operates as the Rx signal line of the touch electrode. In step S10, a masking metallic layer is configured on the transparent substrate. The masking metallic layer is configured with a fifth dielectric layer, and the semiconductor pattern layer is configured on the fifth dielectric layer. The semiconductor pattern layer is configured with a first dielectric layer, and the gate line and the touch signal line are arranged on the first dielectric layer. The gate line is arranged right above the masking metallic layer, and the masking metallic layer is arranged right below the touch signal line.

In step S11, configuring a dielectric layer covering a gate line and a touch signal line, and configuring a first through hole on the dielectric layer.

In step S11, configuring a second dielectric layer on the gate line and the touch signal line, configuring a drain and a source on the second dielectric layer, and the drain and the source respectively connects to two ends of the semiconductor pattern layer via a third through hole on the first dielectric layer and the second dielectric layer, and configuring a third dielectric layer to cover the source and the drain.

In step S12, configuring a touch electrode on the dielectric layer, and the touch electrode electrically connects to the touch signal line via the first through hole.

The touch electrode may be one of the common electrode and the pixel electrode or be the combination of the common electrode and the pixel electrode. When the touch electrode is the pixel electrode, the dielectric layer includes a second dielectric layer and a third dielectric layer. At the same time, in step S12, the pixel electrode is configured on the third dielectric layer, i.e., the touch electrode. The pixel electrode electrically connects to one of the source and the drain via the fourth through hole on the third dielectric layer, and the touch electrode electrically connect to the touch signal line via the first through hole. Thus, the first through hole passes through the second dielectric layer and the third dielectric layer. A fourth dielectric layer is configured on the pixel electrode, and the common electrode is configured on the fourth dielectric layer.

In the embodiment, the dielectric layer between the touch electrode and the touch signal line may include at least the second dielectric layer and the third dielectric layer, regardless whether the touch electrode is the common electrode, the pixel electrode, or the combination of the touch electrode and the common electrode. The dielectric layer between the common electrode and the pixel electrode is the fourth dielectric layer. That is, the thickness of the dielectric layer between the touch electrode and the Rx signal line is increased, and the coupling capacitance between the touch electrode and the Rx signal line is reduced. As the Rx signal line may be accomplished by configuring the touch signal line on the same layer with the gate line, the third metal (M3) operating as the touch signal line may be excluded. Thus, one dielectric layer between the pixel electrode and the common electrode may be excluded. The storage capacitance may be increased, and the pixels may be fully charged when the resolution rate is high.

When the touch electrode is the common electrode, the dielectric layer includes the second dielectric layer, the third dielectric layer, and the fourth dielectric layer, which increases the thickness of the dielectric layer between the touch electrode and the Rx signal line, and the coupling capacitance between the touch electrode and the Rx signal line is reduced. In step S11, the pixel electrode is configured on the third dielectric layer, and the pixel electrode electrically connects to one of the source and the drain via the fourth through hole. In step S12, the touch electrode and the common electrode are configured on the fourth dielectric layer. The touch electrode electrically connects to the touch signal line via the first through hole. The first through hole passes through the second dielectric layer, the third dielectric layer, and the fourth dielectric layer.

When the touch electrode is the common electrode, the connection electrode and the pixel electrode may be configured on the same layer. Two ends of the gate line on the dielectric layer are respectively configured with the second through holes such that the connection electrode connects to the touch signal line at two ends of the gate line via the second through hole. At this moment, the second through hole passes through the second dielectric layer and the third dielectric layer.

In view of the above, the touch signal line and the gate line are arranged on the same layer on the substrate. The dielectric layer covers the gate line and the touch signal line, and the dielectric layer is configured with a first through hole. The touch electrode is configured on the dielectric layer, and the touch electrode electrically connects to the touch signal line via the first through hole. The storage capacitance may be increased, and the pixels may be fully charged when the resolution rate is high.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An array substrate, comprising:
a transparent substrate;
a gate line on the transparent substrate;
a touch signal line on the same layer with the gate line, and the touch signal line is arranged on the transparent substrate;
a dielectric layer covering the gate line and the touch signal line, and the dielectric layer is configured with at least one first through hole; and
a touch electrode arranged on the dielectric layer, the touch electrode electrically connects to the touch signal line via the first through hole.

2. The array substrate as claimed in claim 1, wherein the touch electrode is a common electrode, a pixel electrode, or a combination of the common electrode and the pixel electrode.

3. The array substrate as claimed in claim 2, wherein the dielectric layer is configured with the first through holes at two ends of the gate line such that the common electrode connects to the touch signal line at two ends of the gate line via the first through holes.

4. The array substrate as claimed in claim 2, wherein the array substrate further comprises a connection electrode on the same layer with the pixel electrode, the dielectric layer is configured with second through holes at two ends of the gate line such that the connection electrode connects to the touch electrode line at two ends of the gate line via the second through holes.

5. The array substrate as claimed in claim 2, wherein the pixel electrode is arranged on a layer between the layer of the gate line and the touch signal line and the layer of the common electrode.

6. The array substrate as claimed in claim 2, wherein the array substrate further comprises a semiconductor pattern layer, a first dielectric layer, a second dielectric layer, a drain, a source, a third dielectric layer, and a fourth dielectric layer, the first dielectric layer covers the semiconductor pattern layer, the gate line and the touch signal line are arranged on the first dielectric layer, the second dielectric layer further covers the gate line and the touch signal line, the drain and the source are arranged on the second dielectric layer and are respectively connect to two ends of the semiconductor pattern layer via at least one third through hole on the first dielectric layer and the second dielectric layer, the third dielectric layer covers the source and the drain, the pixel electrode is arranged on the third dielectric layer, the pixel electrode electrically connects to one of the source and the drain via a fourth through hole on the third dielectric layer, the fourth dielectric layer covers the pixel electrode, and the common electrode is arranged on the fourth dielectric layer.

7. A manufacturing method of array substrates, comprising:
arranging a gate line and a touch signal line on a transparent substrate, wherein the touch signal line and the gate line are arranged on the same layer on the transparent substrate;
configuring a dielectric layer covering the gate line and the touch signal line, and configuring at least one first through hole on the dielectric layer; and
configuring a touch electrode on the dielectric layer, and the touch electrode electrically connects to the touch signal line via the first through hole.

8. The manufacturing method as claimed in claim 6, wherein the touch electrode is a common electrode, a pixel electrode, or a combination of the common electrode and the pixel electrode.

9. The manufacturing method as claimed in claim 8, wherein the step of configuring a touch electrode on the dielectric layer, and the touch electrode electrically connects to the touch signal line via the first through hole further comprises:
configuring a connection electrode to be on the same layer with the pixel electrode;
configuring second through holes at two ends of the same gate line on the dielectric layer such that the connection electrode connects to the touch signal lines on two ends of the gate line via the second through holes.

10. A liquid crystal panel, comprising:
a color filter (CF) substrate, an array substrate, and a liquid crystal layer between the CF substrate and the array substrate, the array substrate comprises:
a transparent substrate;
a gate line on the transparent substrate;
a touch signal line on the same layer with the gate line, and the touch signal line is arranged on the transparent substrate;
a dielectric layer covering the gate line and the touch signal line, and the dielectric layer is configured with at least one first through hole; and
a touch electrode arranged on the dielectric layer, the touch electrode electrically connects to the touch signal line via the first through hole.

11. The liquid crystal panel as claimed in claim 10, wherein the touch electrode is a common electrode, a pixel electrode, or a combination of the common electrode and the pixel electrode.

12. The liquid crystal panel as claimed in claim 11, wherein the dielectric layer is configured with the first through holes at two ends of the gate line such that the common electrode connects to the touch signal line at two ends of the gate line via the first through holes.

13. The liquid crystal panel as claimed in claim 11, wherein the array substrate further comprises a connection electrode on the same layer with the pixel electrode, the dielectric layer is configured with second through holes at two ends of the gate line such that the connection electrode connects to the touch electrode line at two ends of the gate line via the second through holes.

14. The liquid crystal panel as claimed in claim 11, wherein the pixel electrode is arranged on a layer between the layer of the gate line and the touch signal line and the layer of the common electrode.

15. The liquid crystal panel as claimed in claim 11, wherein the array substrate further comprises a semiconductor pattern layer, a first dielectric layer, a second dielectric layer, a drain, a source, a third dielectric layer, and a fourth dielectric layer, the first dielectric layer covers the semiconductor pattern layer, the gate line and the touch signal line are arranged on the first dielectric layer, the second dielectric layer further covers the gate line and the touch signal line, the drain and the source are arranged on the second dielectric layer and are respectively connect to two ends of the semiconductor pattern layer via at least one third through hole on the first dielectric layer and the second dielectric layer, the third dielectric layer covers the source and the drain, the pixel electrode is arranged on the third dielectric layer, the pixel electrode electrically connects to one of the source and the drain via a fourth through hole on the third dielectric layer, the fourth dielectric layer covers the pixel electrode, and the common electrode is arranged on the fourth dielectric layer.
